(19) United States
(12) Patent Application Publication
(10) Pub. No.: US 2023/0417410 A1
(43) Pub. Date: Dec. 28, 2023

(54) GAS PROCESSING FURNACE AND EXHAUST GAS PROCESSING DEVICE IN WHICH SAME IS USED

(71) Applicant: KANKEN TECHNO CO., LTD., Kyoto (JP)

(72) Inventor: Hiroshi IMAMURA, Kyoto (JP)

(21) Appl. No.: 18/251,260

(22) PCT Filed: Nov. 10, 2020
(86) PCT No.: PCT/JP2020/041924

§ 371 Date: May 1, 2023

(51) Int. Cl. F23G 7/06; B01D 53/70; B01D 53/77; H05H 1/32; B01D 53/00

(52) U.S. Cl. CPC F23G 7/06; B01D 53/70; B01D 53/77; H05H 1/32; B01D 53/005; B01D 2259/818; B01D 2258/0216

(57) ABSTRACT

A gas processing furnace according to the present invention includes: a hollow cylindrical furnace body including a gas processing space therein; a non-transferred plasma jet torch for supplying a plasma jet into the gas processing space; and an electric heater for heating a region of the gas processing space to which the plasma jet is supplied.

### TECHNICAL FIELD

The present invention relates to a gas processing furnace suitable for an abatement process of a hardly decomposable exhaust gas including, for example, perfluoro compounds (PFCs) or the like, and an exhaust gas processing device in which the gas processing furnace is used.

### BACKGROUND ART

At present, as an industrial process including processing and manufacturing products, a wide variety of processes are developed and performed, and types of gases (hereinafter, referred to as “processing-target exhaust gas”) exhausted through such a wide variety of industrial processes are also of a wide variety. Accordingly, various kinds of exhaust gas processing methods and exhaust gas processing devices are selectively used according to the type of processing-target exhaust gas exhausted through the industrial process.

Among these, a plasma type exhaust gas processing method for passing a processing-target exhaust gas through a plasma space to perform decomposition has been prevalent in recent years, as an exhaust gas processing method in semiconductor manufacturing processes. This plasma type exhaust gas processing method also allows a hardly decomposable gas to be decomposed relatively safely in decomposition of a processing-target exhaust gas (abatement-target gas). In particular, an exhaust gas processing device in which wet scrubbers are disposed in front and to the back of a decomposition device (gas processing furnace) using a non-transferred plasma jet can abate any abatement-target component in the processing-target exhaust gas until the concentration of the component becomes a threshold limit value (TLV: an exposure limit) or less, in accordance with a wide variety of conditions in semiconductor manufacturing (see, for example, Patent Literature 1).

### CITATION LIST

### Patent Literature

[PTL 1] Japanese Laid-Open Patent Publication No. 2005-205330

### SUMMARY OF INVENTION

### Technical Problem

“The 2030 Agenda for Sustainable Development” was adopted in the United Nations Summit in September 2015. After that, various discussions and investigations about, for example, efficient use of energy in future have been conducted. Under these circumstances, also, regarding an exhaust gas processing device that includes the above conventional plasma type gas processing furnace and that consumes a relatively large amount of power as energy during heating, it is easily estimated that the needs for high efficiency and energy saving brought about by the high efficiency are growing.

Therefore, a main object of the present invention is to provide a gas processing furnace that can more efficiently utilize electric power energy and maximizes decomposition efficiency for various gases while maintaining advantages of the conventional plasma type gas processing furnace as they are, and an exhaust gas processing device in which the gas processing furnace is used to remarkably improve abatement efficiency for an exhaust gas.

### Solution to Problem

In order to achieve the aforementioned object, the present invention is directed to a gas processing furnace 10 having the following configuration, for example, as shown in FIG. 1 to FIG. 3.

Specifically, the gas processing furnace 10 includes: a hollow cylindrical furnace body 12 including a gas processing space 12a therein; a non-transferred plasma jet torch 14 for supplying a plasma jet P into the gas processing space 12a; and an electric heater 16 for heating a region of the gas processing space 12a to which the plasma jet P is supplied.

The present invention exhibits, for example, the following effects.

Since the gas processing furnace of the present invention includes the electric heater 16 for heating a region of the gas processing space 12a to which the plasma jet P is supplied, the power having been conventionally supplied to the plasma jet torch 14 to generate the plasma jet P is partially delivered to the electric heater 16, so that, in the region of the gas processing space 12a to which the plasma jet P is supplied, a low-temperature region unreachable by the heat of the plasma jet P in the vicinity of an inner circumferential surface of the furnace body 12 can also be heated although the output of the plasma jet P is slightly reduced. That is, the temperature of the entire gas processing space 12a can be remarkably increased. The type of electric heater 16, the amount of power to be delivered to the electric heater 16 instead of the plasma jet torch 14, and the like are selected as appropriate, so that necessary and sufficient heat for decomposing the processing-target gas can be applied to the gas wherever the gas flows in the gas processing space 12a.

In the present invention, preferably, rod-shaped or column-shaped ceramic heaters 16A are used as the electric heaters 16, and are arranged adjacent to each other on one circumference to form an inner wall 12b of the furnace body 12.

In this case, the furnace body 12 can be simply configured, and also the heat generated by the electric heater 16 can be used to heat the gas processing space 12a without waste.

In addition, in the present invention, the ceramic heater 16A is preferably an SiC heater using a silicon carbide heat generator.

In this case, the temperature of the entire region, in the gas processing space 12a, to which the plasma jet P is supplied can be raised to an ultrahigh temperature around 1600° C.

Further, in the present invention, the gas processing space 12a preferably includes airflow control means that allows airflows inside the gas processing space 12a to be controlled and prolongs residence time of fluid.

In this case, the residence time of the processing-target gas inside the gas processing space 12a is prolonged, thus applying more heat to the gas.

The second aspect of the present invention is directed to an exhaust gas processing device in which the above-described gas processing furnace is used, and the exhaust gas processing device includes any one of the above-described gas processing furnaces, and at least one of an inlet scrubber 18 for previously washing, with liquid, a processing-target exhaust gas E to be introduced into the gas processing furnace and an outlet scrubber 20 for cooling an exhaust gas E thermally decomposed in the gas processing furnace and washing the exhaust gas E with liquid.

### Advantageous Effects of Invention

The gas processing furnace according to the present invention uses plasma and electric heaters in a hybrid manner, unlike the conventional plasma type gas processing furnaces that merely use plasma as a heat source. Therefore, the present invention can provide: the gas processing furnace that can more efficiently utilize electric power energy and maximizes decomposition efficiency for various gases while maintaining advantages of the conventional plasma type gas processing furnace as they are; and the exhaust gas processing device in which the gas processing furnace is used to remarkably improve abatement efficiency for an exhaust gas.

### BRIEF DESCRIPTION OF DRAWINGS

FIG. 1 is a sectional view schematically showing one example of an exhaust gas processing device using a gas processing furnace according to one embodiment of the present invention.

FIG. 2 is a schematic end view taken along a line X-X′ in FIG. 1.

FIG. 3 is a schematic view of a horizontally cut end face of a furnace body in a gas processing furnace according to another embodiment of the present invention.

FIG. 4 is a sectional view schematically showing an exhaust gas processing device according to another embodiment of the present invention.

### DESCRIPTION OF EMBODIMENTS

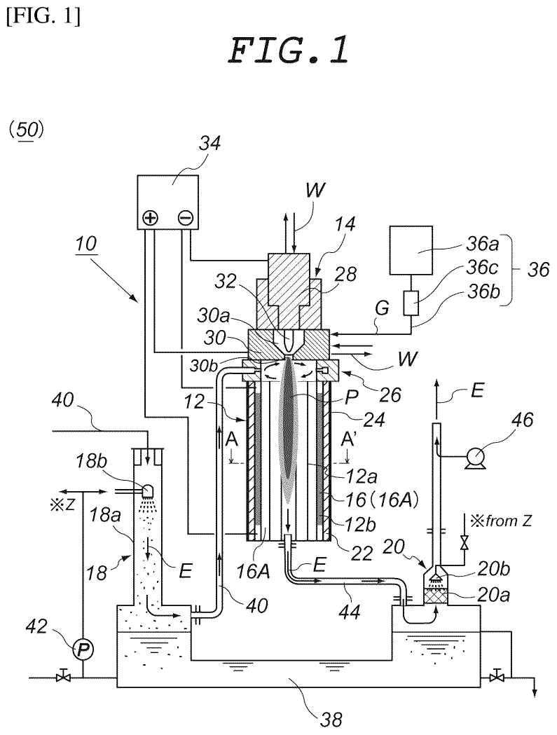

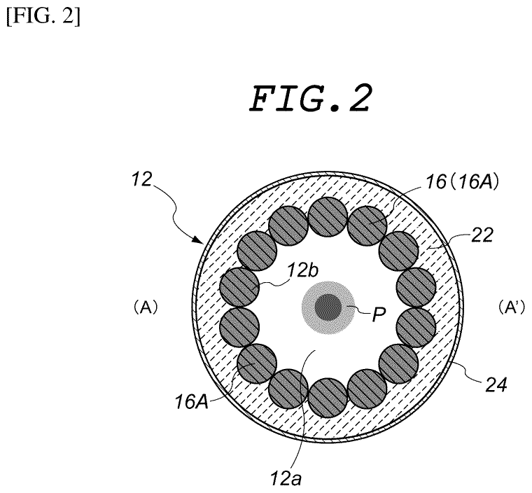

Hereinafter, an embodiment of a gas processing furnace and an exhaust gas processing device in which the gas processing furnace is used, according to the present invention, will be described with reference to FIG. 1 and FIG. 2.

FIG. 1 is a sectional view schematically showing one example of an exhaust gas processing device 50 using a gas processing furnace 10 according to one embodiment of the present invention, and FIG. 2 is a schematic diagram of an end face taken along a line X-X′ in FIG. 1. The exhaust gas processing device 50 is a device that thermally decomposes an exhaust gas E exhausted from an exhaust source, which is not shown, to perform an abatement process, and generally includes a gas processing furnace 10, an inlet scrubber 18, and an outlet scrubber 20.

Although the type of processing-target exhaust gas E is not limited, the exhaust gas processing device 50 is particularly suitable for an abatement process of hardly decomposable exhaust gases E, having specified emission standards, such as perfluoro compounds (PFCs), monosilane (SiH₄), and a chlorine-based gas that are exhausted from a semiconductor manufacturing apparatus. Accordingly, the exhaust gas processing device 50 will be described below as an exhaust gas processing device used for an abatement process of the exhaust gas E exhausted from a semiconductor manufacturing apparatus.

The gas processing furnace 10 is a device that thermally decomposes noxious abatement-target gases in the exhaust gas E exhausted through a semiconductor manufacturing process or the like by using a plasma jet P and electric heat in combination, and includes a furnace body 12, a plasma jet torch 14, and an electric heater 16.

The furnace body 12 is a hollow cylindrical straight tube type member having openings at upper and lower sides thereof and includes a gas processing space 12a therein. In the gas processing furnace 10 of the present embodiment, an inner wall 12b demarcating the gas processing space 12a is formed by the electric heaters 16 (described in detail below), as shown in FIG. 2. An outer circumference of the inner wall 12b formed by the electric heaters 16 is surrounded by a heat-insulating material 22 such as a castable refractory material, and further, an outer circumference of the heat-insulating material 22 is coated by a metal jacket 24 made of, for example, stainless steel or the like.

The furnace body 12 has an upper opening connected to the plasma jet torch 14 through a processing gas supply unit 26 and a lower opening serving as an exhaust port for a gas thermally decomposed in the gas processing space 12a.

The processing gas supply unit 26 is a device that is connected to an ejection side for the plasma jet P of the plasma jet torch 14, surrounds the vicinity of an upstream part on the ejection side of the plasma jet P generated by the plasma jet torch 14, and spirally blows and supplies a processing-target gas (exhaust gas E in the present embodiment) toward the plasma jet P inside the gas processing space 12a.

The plasma jet torch 14 is a device for generating the plasma jet P having a high temperature, and in the present embodiment, a non-transferred plasma jet torch using DC arc discharge is used as the plasma jet torch 14. In addition, the plasma jet torch 14 has a torch body 28 made of a metal material such as brass. An anode 30 is connected to a tip (lower end in FIG. 1) of the torch body 28 and a rod-shaped cathode 32 is attached therein.

The anode 30 is made of a high-melting point metal such as copper, a copper alloy, nickel, or tungsten having high conductivity, and is a cylindrical nozzle electrode having a plasma generation chamber 30a formed so as to be recessed therein. An ejection hole 30b for ejecting the ultrahigh-temperature plasma jet P generated inside the plasma generation chamber 30a is formed at the center portion of a lower surface of the anode 30 so as to penetrate therethrough.

The cathode 32 is a rod-shaped electrode member made of, for example, tungsten having thorium or lanthanum mixed therein and having an outer diameter that is reduced toward its tip so as to form a spindle shape, and a tip part of the cathode 32 is disposed in the above-described plasma generation chamber 30a.

A electrical insulating material (not shown) such as tetrafluoroethylene resin or ceramic is interposed between the anode 30 and the cathode 32 to prevent current from being carried (short-circuiting) therebetween through the torch body 28. In addition, a cooling water passage (not shown) is disposed inside the anode 30 and the cathode 32 to cool the anode 30 and the cathode 32. A reference sign W in FIG. 1 represents a flow of the cooling water.

The anode 30 and the cathode 32 of the plasma jet torch 14 configured as described above are connected to a power supply unit 34 that applies a predetermined discharge voltage to generate an arc between the anode 30 and the cathode 32. As the power supply unit 34, a so-called switching type DC power supply device is preferable.

The plasma jet torch 14 configured as described above is also provided with plasma-generating fluid supply means 36.

The plasma-generating fluid supply means 36 is for supplying at least one selected from the group consisting of nitrogen, oxygen, argon, helium, and water into the plasma generation chamber 30a of the anode 30, as a fluid G for generating high-temperature plasma, and includes a storage tank 36a that stores therein the fluid G and a tube system 36b that allows the storage tank 36a to communicate with the plasma generation chamber 30a of the anode 30. In addition, flow rate control means 36c such as a massflow controller is mounted to the tube system 36b.

The electric heater 16 is means for heating a region, in the gas processing space 12a of the furnace body 12, to which the plasma jet P is supplied, and the type of heat source is selected as appropriate according to the thermal decomposition temperature or the like of the processing-target gas. In the present embodiment, the processing-target gas is an exhaust gas E exhausted from a semiconductor manufacturing apparatus. Thus, a rod-shaped or column-shaped ceramic heater 16A using, as a heat generator, ceramic, such as silicon carbide (SiC), molybdenum disilicide (MoSi₂), or lanthanum chromite (LaCrO₃) that has excellent corrosion resistance and can generate heat at high temperatures is adopted, and particularly, an SiC heater that uses silicon carbide (SiC) as a heat generator and can perform heating at around 1600° C. is adopted.

Here, in the gas processing furnace 10 of the present embodiment, the inner wall 12b demarcating the gas processing space 12a is formed by the electric heaters 16 as described above. Specifically, the rod-shaped or column-shaped ceramic heaters 16A are arranged adjacent to each other on one circumference concentric with the plasma jet P (see FIG. 2), and the adjacent ceramic heaters 16A are in a free state without being fixed to each other to form the inner wall 12b. In this way, when the rod-shaped or column-shaped ceramic heaters 16A form the inner wall 12b of the furnace body 12, high-temperature heat generated by the ceramic heaters 16A can be directly used to heat the gas processing space 12a. In addition, since the adjacent ceramic heaters 16A are in a free state without being fixed to each other, a stress or the like caused by a thermal expansion due to the heat generated by the ceramic heaters 16A can be dispersed, thus operating the furnace body 12 stably for a long time. Even when the adjacent ceramic heaters 16A are in a free state without being fixed to each other, the inside of the gas processing space 12a is under negative pressure by the action of an exhaust fan 46 described below. Thus, there is no possibility that the processing-target exhaust gas E leaks outside from the furnace body 12.

In addition, each electric heater 16 forming the inner wall 12b is connected to the power supply unit 34 that supplies power to the plasma jet torch 14, and the power to be supplied to the plasma jet torch 14 is partially delivered (supplied) to each electric heater 16.

Although not shown, for example, temperature measurement means such as a thermocouple for detecting the temperature of the gas processing space 12a is mounted in the gas processing furnace 10 configured as described above, and the temperature data (temperature signal) detected by the temperature measurement means is provided via a signal line to control means composed of a central processing unit (CPU), a memory, an input device, a display device, and the like. The above-described power supply unit 34 is also connected to the control means.

The gas processing furnace 10 of the present embodiment is installed so as to stand on a storage tank 38 that stores therein a chemical liquid such as water.

The inlet scrubber 18 is a wet scrubber for eliminating dust, water-soluble components, and the like contained in the exhaust gas E to be introduced into the gas processing furnace 10, and includes a straight tube type scrubber body 18a, and a spray nozzle 18b that is installed in the vicinity of the top of the scrubber body 18a in the scrubber body 18a and that sprays a chemical liquid such as water in an atomized state.

The inlet scrubber 18 of the present embodiment is provided at a location in an inflow tube system 40 having an upstream end connected to a semiconductor manufacturing apparatus (not shown) that is an exhaust gas supply source. The inlet scrubber 18 is also installed so as to stand on the storage tank 38 that stores therein a chemical liquid such as water, and allows drainage to be delivered to the storage tank 38.

A circulation pump 42 is installed between the spray nozzle 18b and the storage tank 38 so as to raise the chemical liquid stored in the storage tank 38 up to the spray nozzle 18b.

The outlet scrubber 20 is a wet scrubber for cooling the thermally decomposed exhaust gas E that has passed through the gas processing furnace 10, and finally eliminating dust, water-soluble components, and the like produced as a byproduct through thermal decomposition from the exhaust gas E, and includes a cleaning layer 20a communicating with an opening formed in a bottom of the furnace body 12 of the gas processing furnace 10 through an exhaust tube 44, and a spray nozzle 20b provided right above the cleaning layer 20a. The outlet scrubber 20 is installed so as to stand on the storage tank 38 and allows drainage to be delivered to the storage tank 38.

Similarly to the above-described inlet scrubber 18, in the outlet scrubber 20 of the illustrated embodiment, the circulation pump 42 is installed between the spray nozzle 20b and the storage tank 38 so as to raise the chemical liquid stored in the storage tank 38 up to the spray nozzle 20b. However, instead of the chemical liquid stored in the storage tank 38, another chemical liquid may be supplied, for example, water may be supplied anew, to the spray nozzle 20b.

An outlet of the outlet scrubber 20 is connected to the exhaust fan 46 for releasing the processed exhaust gas E to the atmosphere.

Corrosion-resistant lining or coating is applied, using vinyl chloride, polyethylene, unsaturated polyester resin, fluororesin, or the like, to parts other than the gas processing furnace 10 of the exhaust gas processing device 50 according to the present embodiment, to protect each part from corrosion due to corrosive components such as hydrofluoric acid contained in the exhaust gas E or produced by decomposition of the exhaust gas E.

Further, when the exhaust gas E is abated using the exhaust gas processing device 50 configured as described above, an operation switch (not shown) of the exhaust gas processing device 50 is firstly turned on to operate the plasma jet torch 14 and the electric heaters 16 of the gas processing furnace 10, thereby starting heating the gas processing space 12a in the furnace body 12.

When the temperature inside the gas processing space 12a reaches a predetermined temperature, in a range of 800° C. to 1600° C., corresponding to the type of processing-target exhaust gas E, the exhaust fan 46 operates to start introduction of the exhaust gas E into the exhaust gas processing device 50. Then, the exhaust gas E passes through the inlet scrubber 18, the gas processing furnace 10, and the outlet scrubber 20 in this order, to abate abatement-target components in the exhaust gas E. In addition, the control means, which is not shown, controls the amount of power to be supplied to the plasma jet torch 14 and the electric heaters 16 of the gas processing furnace 10 so as to maintain a predetermined temperature inside the gas processing space 12a.

Since the exhaust gas processing device 50 of the present embodiment includes the electric heater 16 for heating a region of the gas processing space 12a to which the plasma jet P is supplied, the power having been conventionally supplied to the plasma jet torch 14 to generate the plasma jet P is partially delivered to the electric heater 16, so that a low-temperature region unreachable by the heat of the plasma jet P in the gas processing space 12a can also be heated, and the temperature of the entire gas processing space 12a can be increased although the output of the plasma jet P is slightly reduced. In particular, in the present embodiment, an SiC heater is used as the electric heater 16, and thus the temperature of the entire region, in the gas processing space 12a, to which the plasma jet P is supplied can be raised to around 1600° C. For example, a hardly decomposable CF₄ can be assuredly thermally decomposed wherever the CF₄ flows in the gas processing space 12a.

In addition, in the exhaust gas processing device 50 of the present embodiment, since the inlet scrubber 18 is provided, clogging and the like in a downstream part of the inflow tube system 40 or the processing gas supply unit 26 can be prevented by previously washing, with liquid, the exhaust gas E to be introduced into the gas processing furnace 10 and the gas processing furnace 10 can be continuously operated more stably, and since the outlet scrubber 20 is provided, cleanliness of the exhaust gas E thermally decomposed can be improved.

The above described embodiment shown in FIG. 1 and FIG. 2 can be modified as follows.

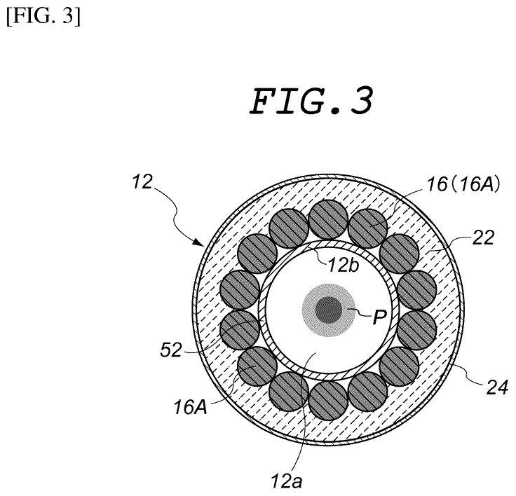

In the gas processing furnace 10 of the above-described embodiment, the inner wall 12b of the furnace body 12 is formed by the ceramic heaters 16A. However, as shown in FIG. 3, the inner wall 12b of the furnace body 12 may be, for example, formed by a circular tube-shaped inner wall material 52 made of a highly heat-resistant metal material such as stainless steel or Hastelloy (registered trademark of Haynes International), a heat-insulating material such as a castable refractory material, or the like, and the electric heaters 16 may be arranged at an outer circumference of the inner wall material 52 to heat the region of the gas processing space 12a to which the plasma jet P is supplied. In this case, as the electric heater 16, not only the rod-shaped or column-shaped ceramic heater 16A but also a heater in which a metal heat generator such as a nichrome wire or Kanthal (registered trademark of Sandvik AB) wire is housed in a hollow tubular or a half tubular sheath may be used, for example.

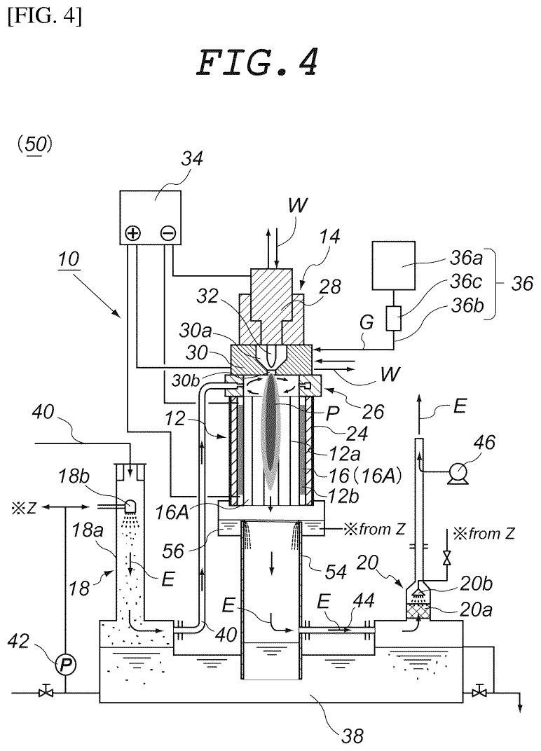

In addition, in the gas processing furnace 10 of the above-described embodiment, the entire gas processing space 12a inside the furnace body 12 is a region to which the plasma jet P is supplied. However, for example, as shown in FIG. 4, a lower cylinder 54 having the same inner diameter as the inner wall 12b may be connected below the inner wall 12b formed by the ceramic heaters 16A to extend the gas processing space 12a, and chemical liquid supply means 56 for flowing down the chemical liquid raised from the storage tank 38 to cover an inner surface of the lower cylinder 54 with the chemical liquid may be provided at an upper end of the lower cylinder 54. When water is used as a chemical liquid to cover the inner surface of the lower cylinder 54, such chemical liquid supply means 56 is provided, whereby the water receives heat from the plasma jet P or the electric heaters 16 and evaporates, and the evaporated water (water vapor) further receives heat to be dissociated into oxygen and hydrogen. Oxygen and hydrogen generated in this way react with the processing-target exhaust gas E in the extended gas processing space 12a to contribute to decomposition of the exhaust gas E.

The gas processing furnace 10 of the above-described embodiment has a plain configuration in which nothing is set in the gas processing space 12a inside the furnace body 12. However, the gas processing space 12a may include airflow control means (not shown) such as a baffle that is made of a highly corrosion-resistant metal, ceramic, or the like such that airflows in the gas processing space 12a are controlled to prolong residence time of fluid (=processing-target exhaust gas E), for example. When such airflow control means is provided, the residence time for the exhaust gas E that passes through the gas processing space 12a can be prolonged in the gas processing space 12a, and thermal decomposition efficiency for the exhaust gas E can be further improved.

Furthermore, in the gas processing furnace 10 of the above-described embodiment, the plasma jet torch 14 and the electric heaters 16 are connected to the same power supply unit 34 to supply power. However, the plasma jet torch 14 and the electric heater 16 may be connected to separate power supply units (not shown), respectively.

In the exhaust gas processing device 50 of the above-described embodiment, both the inlet scrubber 18 and the outlet scrubber 20 are provided. However, either one of the inlet scrubber 18 and the outlet scrubber 20 may be provided according to the type of exhaust gas E to be processed. In addition, the inlet scrubber 18 and the outlet scrubber 20 are installed so as to stand on the storage tank 38. However, the inlet scrubber 18 and the outlet scrubber 20 may be arranged separately from the storage tank 38 and connected to the storage tank 38 via piping to deliver drainage from each of the scrubbers 18 and 20 to the storage tank 38.

### INDUSTRIAL APPLICABILITY

The exhaust gas processing device of the present invention can more efficiently utilize electric power energy and maximize decomposition efficiency for various gases, compared to one using the conventional plasma type gas processing furnace. Therefore, the exhaust gas processing device of the present invention can be used for not only thermal decomposition of the exhaust gas exhausted through the above-described semiconductor manufacturing process, but also decomposition of the exhaust gas exhausted through any industrial process, for example, heat treatment of the exhaust gas in chemical plants. In addition, the gas processing furnace of the present invention can be used for not only thermal decomposition of the exhaust gas but also heat treatment of various gases in industrial processes.

### REFERENCE SIGNS LIST

10 gas processing furnace
12 furnace body
12a gas processing space
12b inner wall
14 plasma jet torch
16 electric heater
16A ceramic heater
18 inlet scrubber
20 outlet scrubber
50 exhaust gas processing device
E exhaust gas
P plasma jet

1. (canceled)

2. A gas processing furnace comprising: a hollow cylindrical furnace body including a gas processing space therein;
a non-transferred plasma jet torch for supplying a plasma jet into the gas processing space; and
an electric heater for heating a region of the gas processing space to which the plasma jet is supplied, wherein
the electric heater is a rod-shaped or column-shaped ceramic heater, and
the ceramic heaters are arranged adjacent to each other on one circumference and the ceramic heaters are in a free state without being fixed to each other to form an inner wall of the furnace body.

3. The gas processing furnace according to claim 2, wherein the ceramic heater is an SiC heater using a silicon carbide heat generator.

4. The gas processing furnace according to claim 2, wherein airflow control means that allows airflows inside the gas processing space to be controlled and prolongs residence time of fluid, is disposed in the gas processing space.

5. An exhaust gas processing device, comprising:
the gas processing furnace according to claim 2; and
at least one of an inlet scrubber for previously washing, with liquid, a processing-target exhaust gas to be introduced into the gas processing furnace and an outlet scrubber for cooling an exhaust gas thermally decomposed in the gas processing furnace and washing the exhaust gas with liquid.
